(19) United States
(12) Patent Application Publication
(10) Pub. No.: US 2017/0145269 A1
(43) Pub. Date: May 25, 2017

(54) SOLVENT-FREE ADHESIVE COMPOSITION

(71) Applicant: Industrial Technology Research Institute, Hsinchu (TW)

(72) Inventors: Ruei-Shin Chen, Hsinchu City (TW); Chao-Chieh Chiang, Kaohsiung City (TW); Wen-Hann Chou, New Taipei City (TW); Hsu-Tzu Fan, Hualien County (TW)

(21) Appl. No.: 14/983,487

(22) Filed: Dec. 29, 2015

(30) Foreign Application Priority Data
Nov. 20, 2015 (TW) 104138378

(51) Int. Cl. C09J 175/06

(52) U.S. Cl. CPC C09J 175/06

(57) ABSTRACT

A solvent-free adhesive composition is provided. The solvent-free adhesive composition includes 80 wt. % to 95 wt. % of polyol prepolymer and 5 wt. % to 20 wt. % of diol prepolymer, wherein the diol prepolymer contains at least 20 wt. % of diol prepolymer having alkyl group in side chain.

### CROSS-REFERENCE TO RELATED APPLICATION

This application claims the priority benefit of Taiwan application serial no. 104138378, filed on Nov. 20, 2015. The entirety of the above-mentioned patent application is hereby incorporated by reference herein and made a part of specification.

### TECHNICAL FIELD

The disclosure relates to an adhesive, and particularly relates to a solvent-free adhesive.

### BACKGROUND

An adhesive is a material that bonds two substrates. Normally, the adhesive is coated on one of the substrates, and the other substrate is pressed to the substrate to bond the two substrates. Thus, the adhesive is required to exhibit at least characteristics such as good coating fluidity and good green strength, etc.

In the shoe-making industry, polyurethane (PUR) resin is commonly used as the adhesive for adhering flat-sole sports footwear materials. However, the green strength of PUR resin is less than desirable, and thus only suitable for the flat-sole sports footwear. A high green strength and low viscosity adhesive is thus required for the high tensile, curved-shaped sports footwear that has a high market share. Besides, since the adhering process of sports footwear is becoming more and more automated, the adhesive needs to exhibit a preferable coating fluidity (i.e., low viscosity) as well as a high green strength. However, the conventional adhesives for the adhering process of sports footwear do not exhibit these characteristics at the same time.

### SUMMARY

A solvent-free adhesive composition according to an embodiment of the disclosure includes 80 wt. % to 95 wt. % of a polyol prepolymer and 5 wt. % to 20 wt. % of a diol prepolymer. In addition, in a total weight of the diol prepolymer, the diol prepolymer contains at least 20 wt. % of a diol prepolymer having an alkyl group in the side chain.

Several exemplary embodiments accompanied with figures are described in detail below to further describe the disclosure in details.

### DETAILED DESCRIPTION OF DISCLOSED EMBODIMENTS

An adhesive composition of the disclosure mainly includes a polyol prepolymer and a diol prepolymer. In a total weight of the adhesive composition, a content of the polyol prepolymer is in a range from 80 wt. % to 95 wt. %, and a content of the diol prepolymer is in a range from 5 wt. % to 20 wt. %. In other words, the adhesive composition of the disclosure mainly includes a polyol prepolymer having a high weight-average molecular weight (referred to as molecular weight hereinafter) and a diol prepolymer having a low molecular weight. Also, the adhesive composition of the disclosure does not contain any solvent. Thus, the adhesive composition of the disclosure is a solvent-free adhesive composition.

In the disclosure, the term “polyol” generally refers to an alcohol-based compound having a molecular weight greater than 600, whereas the term “diol” generally refers to an alcohol-based compound having a molecular weight equal to or lower than 600.

A polyol prepolymer is formed by reacting polyol with isocyanate. The polyol may be polyether polyol or polyester polyol. Examples of polyether polyol include polyethylene glycol (PEG), polypropylene glycol (PPG) and polytetramethylene glycol (PTMG), for example. Examples of polyester polyol include polycaprolactone (PCL), poly(butanediol-co-adipate) glycol (PBA) copolymer and poly(hexanediol-co-adipate) glycol (PHA) copolymer, for example. In the disclosure, the polyester polyol may be used solely, or at least two polyester polyols may be used in mixture. In addition, the polyether polyol may be used solely, or at least two polyether polyols may be used in mixture. Furthermore, the polyester polyol and the polyether polyol may also be used in mixture. In the disclosure, the polyol prepolymer may be formed by reacting polyol with isocyanate and then chain extending with diol to form a polyol prepolymer having a larger molecular weight or a broader molecular weight distribution. The diol may be 1,3-propanediol, 1,4-butanediol, 1,5-pentanediol, 1,6-hexanediol, cyclohexanediol, for example. In addition, the diol may be used solely, or at least two diols may be used in mixture. Examples of the isocyanate include hexamethylene diisocyanate, diphenylmethane diisocyanate, toluene diisocyanate, isophorone diisocyanate, dicyclohexylmethane diisocyanate and xylene diisocyanate, for example. In the disclosure, the isocyanate may be used solely, or at least two isocyanates may be used in mixture.

The diol prepolymer is formed by reacting diol with isocyanate. In the disclosure, the diol prepolymer may be used solely, or at least two diol prepolymers may be used in mixture. Examples of the isocyanate are the same as those described above, and thus not repeated in the following. The diol may be a diol with a carbon number from 3 to 22, such as glyceryl monostearate, trimethyl pentanediol, neopentyl glycol, or 1,2-propanediol. Thus, the diol prepolymer obtained by reacting diol with isocyanate is a diol prepolymer having an alkyl in the side chain with a carbon number from 19 to 38. In the disclosure, the diol may be used solely, or at least two diols may be used in mixture.

Also, in the disclosure, in addition to reacting the diol described above with isocyanate, other diols, such as 1,3-propanediol, 1,4-butanediol, 1,5-pentanediol, 1,6-hexanediol, cyclohexanediol, 1,8-octanediol, cyclohexane dimethanol, phenyldimethanol, benzenedimethanol, hydrotoluquinone, or bisphenol A, for example, may also be used together. The diols described above may be used solely or at least two or more of these diols may be used in mixture. The diol prepolymer formed by reacting the diols described above with isocyanate is a diol prepolymer without an alkyl in the side chain. Namely, in the adhesive composition of the disclosure, the diol prepolymer may simultaneously contain the diol prepolymer having an alkyl group in the side chain and the diol prepolymer without an alkyl group in the side chain. Under such circumstance, in the total weight of the diol prepolymer, a content of the diol prepolymer having an alkyl group in the side chain is at least 20 wt. %. If the content of the diol prepolymer having an alkyl group in side chain is less than 20 wt. %, an open time of the adhesive composition is not desirable (too short).

In an embodiment, the molecular weight of the polyol prepolymer is in a range from 3000 to 7000, for example, whereas the molecular weight of the diol prepolymer is equal to or lower than 1000, for example.

The adhesive composition according to an embodiment of the disclosure includes 80 wt. % to 95 wt. % of the polyol prepolymer and 5 wt. % to 20 wt. % of the diol prepolymer at the same time. In addition, in the total weight of the diol prepolymer, the diol prepolymer contains at least 20 wt. % of the diol prepolymer having an alkyl group in the side chain. Since the polyol prepolymer having a high molecular weight makes the green strength of the adhesive composition high, the diol prepolymer having a low molecular weight makes the viscosity of the adhesive composition low, and the diol prepolymer having an alkyl group in the side chain makes the open time of the adhesive composition long, the adhesive composition of the disclosure exhibits characteristics of a lower viscosity, a higher green strength, and a longer open time at the same time by adopting the specific design of components. Accordingly, when the adhesive composition of the disclosure is used to bond two base materials, particularly when the adhesive composition is applied to bond sports footwear materials, the adhesive composition of the disclosure may be coated uniformly, and the green strength after bonding may be high. Also, since the adhesive composition of the disclosure has a lower viscosity and exhibits a preferable coating fluidity, the adhesive composition of the disclosure is suitable for an automated adhering process.

In other embodiments, further to the polyol prepolymer and the diol prepolymer, the adhesive composition may further include an additive. The additive is a catalyst, for example. Examples of the catalyst include amine catalyst, tin catalyst, and transition metal catalyst. The catalyst may be used solely, or at least two catalysts may be used in mixture. The catalyst may facilitate a chemical reaction and generate a green strength. In an embodiment, in the total weight of the adhesive composition, a content of the catalyst is 3 wt. % or less. Also, the additive may also be a crosslinker or a tackifier.

In the following, embodiments (the adhesive compositions of the disclosure) and a comparative example are provided to set forth the properties that the adhesive composition of the disclosure exhibits.

### Embodiment 1

240.12 g of poly(butanediol-co-adipate) glycol (PBA3000) was reacted with 29.60 g of hexamethylene diisocyanate (HDI) to form a mixture having a molecular weight in a range from 3000 g/mol to 4000 g/mol. Then, 0.31 g of 1,4-butanediol (1,4-BD) was added, and a portion (less than 10%) of the mixture was reacted to form a polyol prepolymer having a higher molecular weight (from 6000 g/mol to 7000 g/mol), and a content of the polyol prepolymer was 88% of the total weight of the final adhesive composition. Then, a diol prepolymer formed by reacting 0.91 g of 1,4-BD with 2.63 g of HDI, a diol prepolymer formed by reacting 4.46 g of cyclohexanedimethanol (CHDM)with 10.82 g of HDI, a diol prepolymer formed by reacting 9.16 g of glycerol monostearate (GMS) with 8.75 g of HDI and 0.01 g of a bismuth catalyst K348 were sequentially added to form an adhesive composition. An average molecular weight of the diol prepolymers are equal to or lower than 1000 g/mol.

### Embodiment 2

240.24 g of PBA3000 was reacted with 29.77 g of HDI to form a mixture having a molecular weight in a range from 3000 g/mol to 4000 g/mol. Then, 0.18 g of 1,4-BD was added, and a portion (less than 10%) of the mixture was reacted to form a polyol prepolymer having a higher molecular weight (the molecular weight thereof ranges from 6000 g/mol to 7000 g/mol), and a content of the polyol prepolymer was 88% of the total weight of the final adhesive composition. Then, a diol prepolymer formed by reacting 1.04 g of 1,4-BD with 3.01g of HDI, a diol prepolymer formed by reacting 4.53 g of CHDM with 10.79 g of HDI, a diol prepolymer formed by reacting 9.18 g of GMS with 8.68 g of HDI were sequentially added to form an adhesive composition. An average molecular weight of the diol prepolymers are equal to or lower than 1000 g/mol.

### Embodiment 3

480.83 g of PBA3000 was reacted with 59.31 g of HDI to form a mixture having a molecular weight in a range from 3000 g/mol to 4000 g/mol. Then, 0.61 g of 1,4-BD was added, and a portion (less than 10%) of the mixture was reacted to form a polyol prepolymer having a higher molecular weight (the molecular weight thereof ranges from 6000 g/mol to 7000 g/mol), and a content of the polyol prepolymer was 88% of the total weight of the final adhesive composition. Then, a diol prepolymer formed by reacting 1.74 g of 1,4-BD with 4.89 g of HDI, a diol prepolymer formed by reacting 8.99 g of CHDM with 21.31 g of HDI, a diol prepolymer formed by reacting 18.38 g of GMS with 18.24 g of HDI and 0.04 g of a bismuth catalyst K348 were sequentially added to form an adhesive composition. An average molecular weight of the diol prepolymers are equal to or lower than 1000 g/mol.

### COMPARATIVE EXAMPLE

200 g of PBA 1000 and 67.2 g of HDI were added to a reaction tank for polymerization. Then, 36 g of 1,4-BD was reacted with an obtained product. Then, 67.2 g of HDI was reacted with an obtained product to form the adhesive composition. An average molecular weight of the obtained prepolymer was higher than 10000 g/mol.

In the following, the adhesive compositions of Embodiments 1 to Embodiments 3 and the comparative example were tested. The tests include the measurements of viscosity of the adhesive composition at 170° C., measurements of open time when the adhesive composition was melted and then placed at room temperature, and measurements of three-minute green strength when the adhesive composition was applied to bond rubber substrate. The obtained results are shown in Table 1.

TABLE 1

| | Three-minute green | Viscosity at | Open time |
|---|---|---|---|
| | strength | 170° C. | (sec.) |
| | (kg/cm) | (cps) | (touched by |
| | (ASTM D1876) | (ASTM D3236) | hand)* |
| Embodiment 1 | 3.33 | 9295 | greater than 30 |
| Embodiment 2 | 3 | 9696 | greater than 30 |
| Embodiment 3 | 3.7 | 9449 | greater than 30 |
| Comparative | 0.8 | 3953 | 10 |
| Example | | | |

*Note:
touch with finger every 10 seconds and no sticking feeling

As shown in Table 1, compared with the comparative example, the adhesive composition of the disclosure (Embodiments 1 to 3) are superior in terms of three-minute green strength, viscosity at 170° C., and open time. Also, in Embodiment 2, even though the adhesive composition does not contain a catalyst, the adhesive composition of Embodiment 2 still has a low viscosity (lower than 10000 cps) and a high green strength (greater than 3 kg/cm).

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A solvent-free adhesive composition, comprising:
80 wt. % to 95 wt. % of polyol prepolymer; and
5 wt. % to 20 wt. % of a diol prepolymer, wherein in a total weight of the diol prepolymer, the diol prepolymer contains at least 20 wt. % of a diol prepolymer having an alkyl group in a side chain.

2. The solvent-free adhesive composition as claimed in claim 1, wherein the polyol prepolymer is formed by reacting polyol with isocyanate and then diol is added as chain extender.

3. The solvent-free adhesive composition as claimed in claim 2, wherein the polyol comprises polyether polyol, polyester polyol, or a combination thereof.

4. The solvent-free adhesive composition as claimed in claim 2, wherein the isocyanate comprises hexamethylene diisocyanate, diphenylmethane diisocyanate, toluene diisocyanate, isophorone diisocyanate, dicyclohexylmethane diisocyanate, xylene diisocyanate, or a combination thereof.

5. The solvent-free adhesive composition as claimed in claim 2, wherein the diol comprises 1,3-propanediol, 1,4-butanediol, 1,5-pentanediol, 1,6-hexanediol, cyclohexanediol, or a combination thereof.

6. The solvent-free adhesive composition as claimed in claim 1, wherein the diol prepolymer is foil red by reacting diol with isocyanate.

7. The solvent-free adhesive composition as claimed in claim 6, wherein diol comprises glyceryl monostearate, trimethyl pentanediol, neopentyl glycol, 1,2-propanediol, or a combination thereof.

8. The solvent-free adhesive composition as claimed in claim 7, wherein the diol further comprises 1,3-propanediol, 1,4-butanediol, 1,5-pentanediol, 1,6-hexanediol, cyclohexanediol, 1,8-octanediol, cyclohexane dimethanol, phenyl dimethanol, benzenedimethanol, hydrotoluquinone, bisphenol A, or a combination thereof.

9. The solvent-free adhesive composition as claimed in claim 6, wherein the isocyanate comprises hexamethylene diisocyanate, diphenylmethane diisocyanate, toluene diisocyanate, isophorone diisocyanate, dicyclohexylmethane diisocyanate, xylene diisocyanate, or a combination thereof.

10. The solvent-free adhesive composition as claimed in claim 1, wherein a weight-average molecular weight of the polyol prepolymer is in a range from 3000 to 7000.

11. The solvent-free adhesive composition as claimed in claim 1, wherein a weight-average molecular weight of the diol prepolymer is equal to or lower than 1000.

12. The solvent-free adhesive composition as claimed in claim 1, further comprising 3 wt. % or less of a catalyst.

13. The solvent-free adhesive composition as claimed in claim 12, wherein the catalyst comprises amine catalyst, tin catalyst, transition metal catalyst, or a combination thereof.
